(19) United States
(12) Patent Application Publication
(10) Pub. No.: US 2026/0051551 A1
(43) Pub. Date: Feb. 19, 2026

(54) STORAGE SYSTEM CONFIGURED FOR USE WITH AN ENERGY MANAGEMENT SYSTEM

(71) Applicant: ENPHASE ENERCY, INC., Petaluma, CA (US)

(72) Inventor: Raghuveer R. BELUR, Los Altos, CA (US)

(21) Appl. No.: 19/369,627

(22) Filed: Oct. 27, 2025

Related U.S. Application Data
(63) Continuation-in-part of application No. PCT/US2024/024087, filed on Apr. 11, 2024.
(60) Provisional application No. 63/462,412, filed on Apr. 27, 2023.

(51) Int. Cl. H01M 10/42

(52) U.S. Cl. CPC H01M 10/425; H01M 2010/4271

(57) ABSTRACT

A storage system configured for use with an energy management system is provided and comprises a chassis comprising a plurality of slots configured to house a plurality of batteries and corresponding battery management units and a plurality of microinverters such that a user can selectively add/remove either a battery of the plurality of batteries or a microinverter of the plurality of microinverters to obtain at least one of a predetermined amount of KWh, KW, or C-rate.

### CROSS-REFERENCE TO RELATED APPLICATIONS

The present application is a continuation-in-part bypass application that claims the benefit of and priority to International Application Serial No. PCT/US2024/024087, filed on Apr. 11, 2024, which claims the benefit of and priority to U.S. Provisional Application Ser. No. 63/462,412, filed on Apr. 27, 2023, the entire contents of each of these applications is incorporated herein by reference.

### BACKGROUND

### 1. Field of the Disclosure

Embodiments of the present disclosure generally relate to power systems and, for example, to energy storage systems that comprise a battery architecture that allows for a flexible number of microinverters and/or battery modules to be installed into a chassis.

### 2. Description of the Related Art

Conventional AC storage systems comprise one or more microinverters and/or battery modules (e.g., lithium-ion batteries) and provide a required energy storage (kWh) and a required AC power (kW). The AC storage systems are predominantly driven by standard-size battery units/modules, with users/consumers being able to buy 1, 2, 3, etc. battery units. As the number of battery units increases, the capacity/power scales linearly and the C-rate remains constant. Such inflexibility, however, does not allow users/consumers to customize battery capacity and/or power according to a user's needs. For example, a homeowner may desire high capacity and low power, while another homeowner may desire low capacity and high power.

Therefore, the inventors have provided herein improved energy storage systems that comprise a battery architecture that allows for a flexible number of microinverters and/or battery modules to be installed into a chassis.

### SUMMARY

In accordance with some aspects of the present disclosure, a storage system configured for use with an energy management system comprises a chassis comprising a plurality of slots configured to house a plurality of batteries and corresponding battery management units and a plurality of microinverters such that a user can selectively add/remove either a battery of the plurality of batteries or a microinverter of the plurality of microinverters to obtain at least one of a predetermined amount of KWh, KW, or C-rate.

In accordance with some aspects of the present disclosure, an energy management system comprises a DC power source connected to a power converter to convert DC power from the DC power source to grid-compliant AC power that is coupled to an AC bus and a storage system comprising a chassis comprising a plurality of slots configured to house a plurality of batteries and corresponding battery management units and a plurality of microinverters such that a user can selectively add/remove either a battery of the plurality of batteries or a microinverter of the plurality of microinverters to obtain at least one of a predetermined amount of KWh, KW, or C-rate.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

So that the manner in which the above recited features of the present disclosure can be understood in detail, a more particular description of the disclosure, briefly summarized above, may be had by reference to embodiments, some of which are illustrated in the appended drawings. It is to be noted, however, that the appended drawings illustrate only a typical embodiment of this disclosure and are therefore not to be considered limiting of its scope, for the disclosure may admit to other equally effective embodiments.

FIG. 1 is a block diagram of a system for power conversion, in accordance with at least some embodiments of the present disclosure;

FIG. 2 is a block diagram of an AC battery system, in accordance with at least some embodiments of the present disclosure;

FIG. 3 is a diagram of a chassis comprising a plurality of batteries and microinverters configured for use with the AC battery system of FIG. 2, in accordance with at least some embodiments of the present disclosure;

FIG. 4 is a diagram of a chassis comprising a plurality of batteries and microinverters configured for use with the AC battery system of FIG. 2, in accordance with at least some embodiments of the present disclosure; and

FIG. 5 is a diagram of a chassis comprising a plurality of batteries and microinverters configured for use with the AC battery system of FIG. 2, in accordance with at least some embodiments of the present disclosure.

### DETAILED DESCRIPTION

Energy storage systems comprising a battery architecture that allows for a flexible number of microinverters and/or battery modules to be installed into a chassis are described herein. For example, a storage system configured for use with an energy management system comprises a chassis comprising a plurality of slots configured to house a plurality of batteries and corresponding battery management units and a plurality of microinverters such that a user can selectively add/remove either a battery of the plurality of batteries or a microinverter of the plurality of microinverters to obtain at least one of a predetermined amount of KWh, KW, or C-rate. The chassis allow a user to turn off (or remove, i.e., field swappable) one or more batteries (or microinverters) as needed, which can reduce overall tare loss, or otherwise more intelligently use the one or more batteries. The inventive concepts described herein provide improved mechanical/form factor, base concept of modular microinverter/battery product, and/or battery management unit ((BMU), which can also be referred to as a battery management system (BMS)) intelligence and balancing.

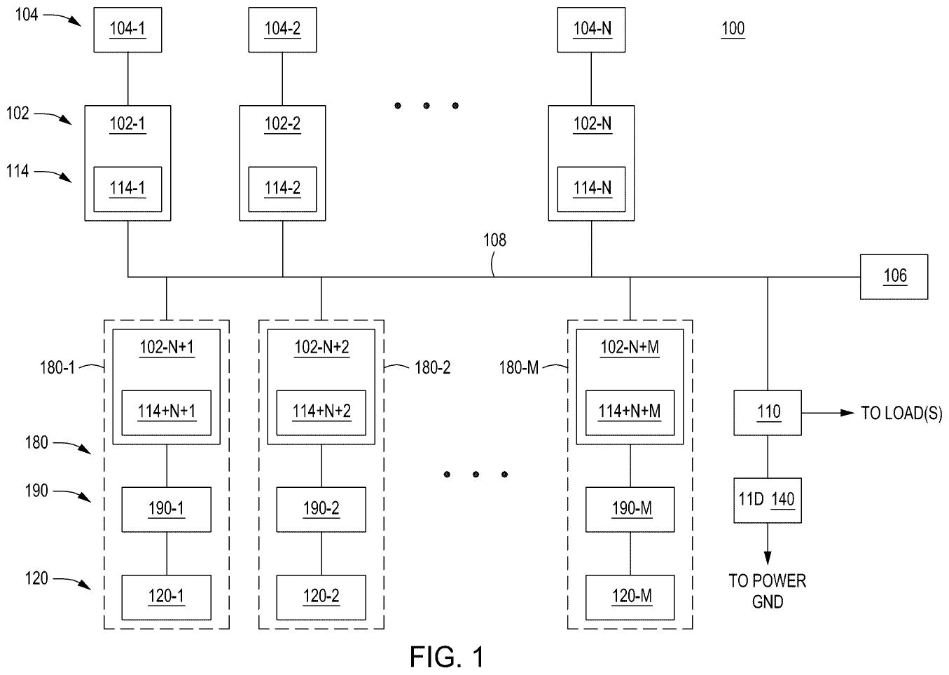

FIG. 1 is a block diagram of a system 100 (an energy management system) for power conversion using one or more embodiments of the present disclosure. This diagram only portrays one variation of the myriad of possible system configurations and devices that may utilize the present disclosure.

The system 100 is a microgrid that can operate in both an islanded state and in a grid-connected state (i.e., when connected to another power grid (such as one or more other microgrids and/or a commercial power grid). The system 100 comprises a plurality of power converters 102-1, 102-2, . . . 102-N, 102-N+1, and 102-N+M collectively referred to as power converters 102 (which also may be called power conditioners, microinverters, or inverters); a plurality of DC power sources 104-1, 104-2, . . . 104-N, collectively referred to as power sources 104; a plurality of energy storage devices/delivery devices 120-1, 120-2, . . . 120-M collectively referred to as energy storage/delivery devices 120; a system controller 106; a plurality of BMUs 190-1, 190-2, . . . 190-M (battery management units) collectively referred to as BMUs 190; a system controller 106; a bus 108; a load center 110; and an IID 140 (island interconnect device, which may also be referred to as a microgrid interconnect device (MID)). In some embodiments, such as the embodiments described herein, the energy storage/delivery devices are rechargeable batteries (e.g., multi-C-rate collection of AC batteries) which may be referred to as batteries 120, although in other embodiments the energy storage/delivery devices may be any other suitable device for storing energy and providing the stored energy. Generally, each of the batteries 120 (e.g., battery packs) comprises a plurality of battery cells that are coupled in series, e.g., eight battery cells coupled in series to form a battery 120.

Each power converter 102-1, 102-2 . . . 102-N is coupled to a DC power source 104-1, 104-2 . . . 104-N, respectively, in a one-to-one correspondence, although in some other embodiments multiple DC power sources may be coupled to one or more of the power converters 102. The power converters 102-N+1, 102-N+2 . . . 102-N+M are respectively coupled to plurality of energy storage devices/delivery devices 120-1, 120-2 . . . 120-M via BMUs 190-1, 190-2 . . . 190-M to form AC batteries 180-1, 180-2 . . . 180-M, respectively. Each of the power converters 102-1, 102-2 . . . 102-N+M comprises a corresponding controller 114-1, 114-2 . . . 114-N+M (collectively referred to as the inverter controllers 114) for controlling operation of the power converters 102-1, 102-2 . . . 102-N+M.

In some embodiments, such as the embodiment described below, the DC power sources 104 are DC power sources and the power converters 102 are bidirectional inverters such that the power converters 102-1 . . . 102-N convert DC power from the DC power sources 104 to grid-compliant AC power that is coupled to the bus 108, and the power converters 102-N+1 . . . 102-N+M convert (during energy storage device discharge) DC power from the batteries 120 to grid-compliant AC power that is coupled to the bus 108 and also convert (during energy storage device charging) AC power from the bus 108 to DC output that is stored in the batteries 120 for subsequent use. The DC power sources 104 may be any suitable DC source, such as an output from a previous power conversion stage, a battery, a renewable energy source (e.g., a solar panel or photovoltaic (PV) module, a wind turbine, a hydroelectric system, or similar renewable energy source), or the like, for providing DC power. In other embodiments the power converters 102 may be other types of converters (such as DC-DC converters), and the bus 108 is a DC power bus.

The power converters 102 are coupled to the system controller 106 via the bus 108 (which also may be referred to as an AC line or a grid). The system controller 106 generally comprises a CPU coupled to each of support circuits and a memory that comprises a system control module for controlling some operational aspects of the system 100 and/or monitoring the system 100 (e.g., issuing certain command and control instructions to one or more of the power converters 102, collecting data related to the performance of the power converters 102, and the like). The system controller 106 is capable of communicating with the power converters 102 by wireless and/or wired communication (e.g., power line communication) for providing certain operative control and/or monitoring of the power converters 102.

In some embodiments, the system controller 106 may be a gateway that receives data (e.g., performance data) from the power converters 102 and communicates (e.g., via the Internet) the data and/or other information to a remote device or system, such as a master controller (not shown). Additionally or alternatively, the gateway may receive information from a remote device or system (not shown) and may communicate the information to the power converters 102 and/or use the information to generate control commands that are issued to the power converters 102.

The power converters 102 are coupled to the load center 110 via the bus 108, and the load center 110 is coupled to the power grid via the IID 140. When coupled to the power grid (e.g., a commercial grid or a larger microgrid) via the IID 140, the system 100 may be referred to as grid-connected; when disconnected from the power grid via the IID 140, the system 100 may be referred to as islanded. The IID 140 determines when to disconnect from/connect to the power grid (e.g., the IID 140 may detect a grid fluctuation, disturbance, outage or the like) and performs the disconnection/connection. Once disconnected from the power grid, the system 100 can continue to generate power as an intentional island, without imposing safety risks on any line workers that may be working on the grid, using the droop control techniques described herein. The IID 140 comprises a disconnect component (e.g., a disconnect relay) for physically disconnecting/connecting the system 100 from/to the power grid. In some embodiments, the IID 140 may additionally comprise an autoformer for coupling the system 100 to a split-phase load that may have a misbalance in it with some neutral current. In certain embodiments, the system controller 106 comprises the IID 140 or a portion of the IID 140.

The power converters 102 convert the DC power from the DC power sources 104 and discharging batteries 120 to grid-compliant AC power and couple the generated output power to the load center 110 via the bus 108. The power is then distributed to one or more loads (for example to one or more appliances) and/or to the power grid (when connected to the power grid). Additionally or alternatively, the generated energy may be stored for later use, for example using batteries, heated water, hydro pumping, H₂O-to-hydrogen conversion, or the like. Generally, the system 100 is coupled to the commercial power grid, although in some embodiments the system 100 is completely separate from the commercial grid and operates as an independent microgrid.

In some embodiments, the AC power generated by the power converters 102 is single-phase AC power. In other embodiments, the power converters 102 generate three-phase AC power.

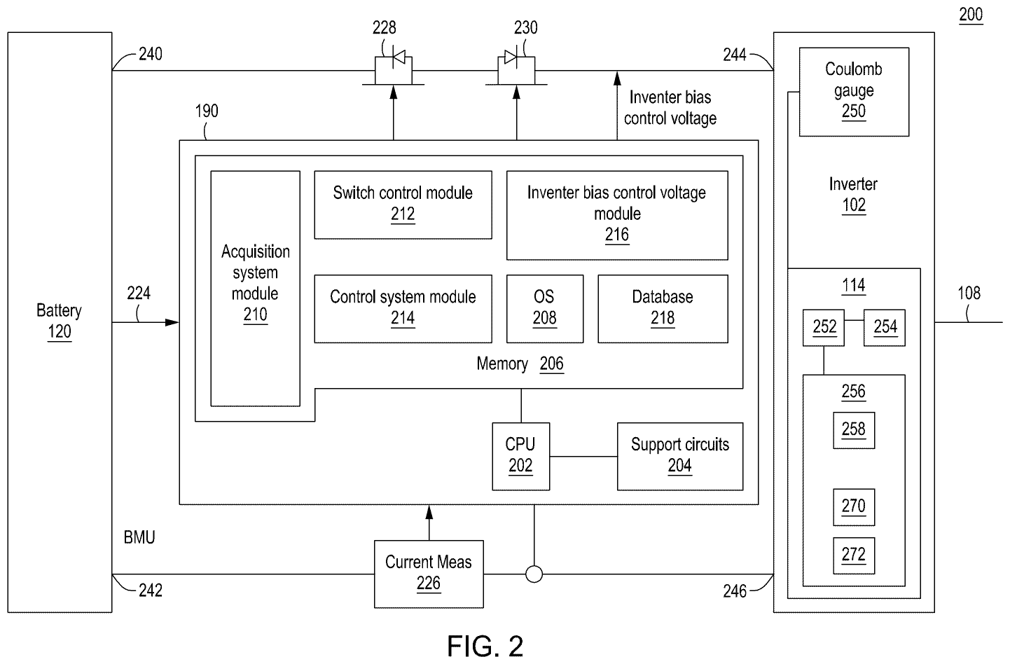

A storage system configured for use with an energy management system, such as the Enphase® Energy System, is described herein. For example, FIG. 2 is a block diagram of an AC battery system 200 (e.g., a storage system) in accordance with one or more embodiments of the present disclosure.

The AC battery system 200 comprises a BMU 190 coupled to a battery 120 and a power converter 102. A pair of metal-oxide-semiconductor field-effect transistors (MOSFETs) switches—switches 228 and 230—are coupled in series between a first terminal 240 of the battery 120 and a first terminal of the inverter 144 such the body diode cathode terminal of the switch 228 is coupled to the first terminal 240 of the battery 120 and the body diode cathode terminal of the switch 230 is coupled to the first terminal 244 of the power converter 102. The gate terminals of the switches 228 and 230 are coupled to the BMU 190.

A second terminal 242 of the battery 120 is coupled to a second terminal 246 of the power converter 102 via a current measurement module 226 which measures the current flowing between the battery 120 and the power converter 102.

The BMU 190 is coupled to the current measurement module 226 for receiving information on the measured current, and also receives an input 224 from the battery 120 indicating the battery cell voltage and temperature. The BMU 190 is coupled to the gate terminals of each of the switches 228 and 230 for driving the switch 228 to control battery discharge and driving the switch 230 to control battery charge as described herein. The BMU 190 is also coupled across the first terminal 244 and the second terminal 246 for providing an inverter bias control voltage (which may also be referred to as a bias control voltage) to the inverter 102 as described further below.

The configuration of the body diodes of the switches 228 and 230 allows current to be blocked in one direction but not the other depending on state of each of the switches 228 and 230. When the switch 228 is active (i.e., on) while the switch 230 is inactive (i.e., off), battery discharge is enabled to allow current to flow from the battery 120 to the power converter 102 through the body diode of the switch 230. When the switch 228 is inactive while the switch 230 is active, battery charge is enabled to allow current flow from the power converter 102 to the battery 120 through the body diode of the switch 228. When both switches 228 and 230 are active, the system is in a normal mode where the battery 120 can be charged or discharged.

The BMU 190 comprises support circuits 204 and a memory 206 (e.g., non-transitory computer readable storage medium), each coupled to a CPU 202(central processing unit). The CPU 202 may comprise one or more processors, microprocessors, microcontrollers and combinations thereof configured to execute non-transient software instructions to perform various tasks in accordance with embodiments of the present disclosure. The CPU 202 may additionally or alternatively include one or more application specific integrated circuits (ASICs). In some embodiments, the CPU 202 may be a microcontroller comprising internal memory for storing controller firmware that, when executed, provides the controller functionality described herein. The BMU 190 may be implemented using a general purpose computer that, when executing particular software, becomes a specific purpose computer for performing various embodiments of the present disclosure.

The support circuits 204 are well known circuits used to promote functionality of the CPU 202. Such circuits include, but are not limited to, a cache, power supplies, clock circuits, buses, input/output (I/O) circuits, and the like. The BMU 190 may be implemented using a general purpose computer that, when executing particular software, becomes a specific purpose computer for performing various embodiments of the present disclosure. In one or more embodiments, the CPU 202 may be a microcontroller comprising internal memory for storing controller firmware that, when executed, provides the controller functionality described herein.

The memory 206 may comprise random access memory, read only memory, removable disk memory, flash memory, and various combinations of these types of memory. The memory 206 is sometimes referred to as main memory and may, in part, be used as cache memory or buffer memory. The memory 206 generally stores the OS 208 (operating system), if necessary, of the inverter controller 114 that can be supported by the CPU capabilities. In some embodiments, the OS 208 may be one of a number of commercially available operating systems such as, but not limited to, LINUX, Real-Time Operating System (RTOS), and the like.

The memory 206 stores non-transient processor-executable instructions and/or data that may be executed by and/or used by the CPU 202 to perform, for example, one or more methods for discharge protection, as described in greater detail below. These processor-executable instructions may comprise firmware, software, and the like, or some combination thereof. The memory 206 stores various forms of application software, such as an acquisition system module 210, a switch control module 212, a control system module 214, and an inverter bias control module 216. The memory 206 additionally stores a database 218 for storing data related to the operation of the BMU 190 and/or the present disclosure, such as one or more thresholds, equations, formulas, curves, and/or algorithms for the control techniques described herein. In various embodiments, one or more of the acquisition system module 210, the switch control module 212, the control system module 214, the inverter bias control module 216, and the database 218, or portions thereof, are implemented in software, firmware, hardware, or a combination thereof.

The acquisition system module 210 obtains the cell voltage and temperature information from the battery 120 via the input 224, obtains the current measurements provided by the current measurement module 226, and provides the cell voltage, cell temperature, and measured current information to the control system module 214 for use as described herein.

The switch control module 212 drives the switches 228 and 230 as determined by the control system module 214. The control system module 214 provides various battery management functions, including protection functions (e.g., overcurrent (OC) protection, overtemperature (OT) protection, and hardware fault protection), metrology functions (e.g., averaging measured battery cell voltage and battery current over, for example, 100 ms to reject 50 and 60 Hz ripple), state of charge (SOC) analysis (e.g., coulomb gauge 250 for determining current flow and utilizing the current flow in estimating the battery SOC; synchronizing estimated SOC values to battery voltages (such as setting SOC to an upper bound, such as 100%, at maximum battery voltage; setting SOC to a lower bound, such as 0%, at a minimum battery voltage); turning off SOC if the power converter 102 never drives the battery 120 to these limits; and the like), balancing (e.g., autonomously balancing the charge across all cells of a battery to be equal, which may be done at the end of charge, at the end of discharge, or in some embodiments both at the end of charge and the end of discharge). By establishing upper and lower estimated SOC bounds based on battery end of charge and end of discharge, respectively, and tracking the current flow and cell voltage (i.e., battery voltage) between these events, the BMU 190 determines the estimated SOC.

The inverter controller 114 comprises support circuits 254 and a memory 256, each coupled to a CPU 252 (central processing unit). The CPU 252 may comprise one or more processors, microprocessors, microcontrollers and combinations thereof configured to execute non-transient software instructions to perform various tasks in accordance with embodiments of the present disclosure. The CPU 252 may additionally or alternatively include one or more application specific integrated circuits (ASICs). In some embodiments, the CPU 252 may be a microcontroller comprising internal memory for storing controller firmware that, when executed, provides the controller functionality herein. The inverter controller 114 may be implemented using a general purpose computer that, when executing particular software, becomes a specific purpose computer for performing various embodiments of the present disclosure.

The support circuits 254 are well known circuits used to promote functionality of the CPU 252. Such circuits include, but are not limited to, a cache, power supplies, clock circuits, buses, input/output (I/O) circuits, and the like. The inverter controller 114 may be implemented using a general purpose computer that, when executing particular software, becomes a specific purpose computer for performing various embodiments of the present disclosure. In one or more embodiments, the CPU 252 may be a microcontroller comprising internal memory for storing controller firmware that, when executed, provides the controller functionality described herein.

The memory 256 may comprise random access memory, read only memory, removable disk memory, flash memory, and various combinations of these types of memory. The memory 256 is sometimes referred to as main memory and may, in part, be used as cache memory or buffer memory. The memory 256 generally stores the OS 258 (operating system), if necessary, of the inverter controller 114 that can be supported by the CPU capabilities. In some embodiments, the OS 258 may be one of a number of commercially available operating systems such as, but not limited to, LINUX, Real-Time Operating System (RTOS), and the like.

The memory 256 stores non-transient processor-executable instructions and/or data that may be executed by and/or used by the CPU 252. These processor-executable instructions may comprise firmware, software, and the like, or some combination thereof. The memory 256 stores various forms of application software, such as a power conversion control module 270 for controlling the bidirectional power conversion, and a battery management control module 272.

The BMU 190 communicates with the system controller 106 to perform balancing of the batteries 120 (e.g., multi-C-rate collection of AC batteries) based on a time remaining before each of the batteries are depleted of charge, to perform droop control (semi-passive) which allows the batteries to run out of charge at substantially the same time, and perform control of the batteries to charge batteries having less time remaining before depletion using batteries having more time remaining before depletion, as described in greater detail below. In at least some embodiments, the BMU 190 and/or the battery 120 can connect to a DC bus (e.g., 60 V) and the BMU 190 can communicate with other components of the system 100 via a DC PLC interface.

The AC battery system 200 comprises a chassis (or similar apparatus, such as a housing) which allows installation of x microinverters (e.g., the power converter 102 and y battery modules (e.g., the battery 120). For example, at a time of purchase and/or installation, a user may specify power needs based on energy loads in-home, which dictates a number of microinverters. The user may specify how much capacity is needed (and how much a user is willing to pay for) and can decide on how many battery modules (e.g., battery packs) to buy independent of a power/microinverter concerns. All battery modules described herein are configured to fit into the chassis with a standard form factor and configured to discharge to a DC bus which feeds the microinverters. As noted above, the chassis allow a user to turn off (or remove, i.e., field swappable) one or more batteries (or microinverters) as needed, which can reduce overall tare loss, or otherwise more intelligently use the one or more batteries. The inventive concepts described herein provide improved mechanical/form factor, base concept of modular microinverter/battery product, and/or BMU/BMS intelligence and balancing.

For example, a design tool (software) is configured to pick the KWh (e.g., battery blocks of 1.4 KWh) and KW (e.g., microinverter blocks of 720 VA) for designing/building a battery back. The benefits of such a battery pack comprises high reliability (distributed architecture), high safety (smaller packs and independent of power), relatively simple installation (e.g., 1 person install), relatively low cost (e.g., due to low DC current), flexible c-rate (e.g., 0.1 to 4 C and anything in-between), expandability and configurability, no wasted of KWh or KW, and an ability for a microinverter's power to continue to increase independent of a battery pack.

The AC battery systems described herein are centered around a common DC bus. For example, the battery packs are configured with an integrated BMU that is configured to connect to the DC bus. The microinverter is also configured to connect to the DC bus. DC power line communication (PLC) or out of band communication can be used by the BMU for communicating, which allows for auto discovery and/or configuration of battery pack and microinverters.

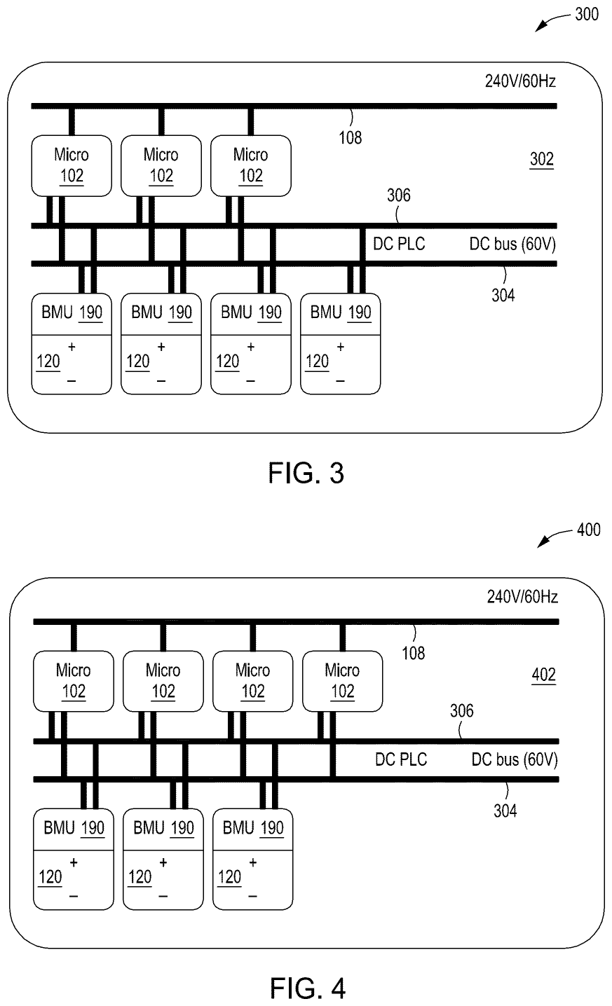

FIG. 3 is a diagram 300 of a chassis comprising a plurality of batteries and microinverters configured for use with the AC battery system of FIG. 2, in accordance with at least some embodiments of the present disclosure. For example, as illustrated in FIG. 3, a battery chassis 302 comprises one or more batteries (e.g., the battery 120) and corresponding BMUs (e.g., the BMU 190) and microinverters (e.g., the power converter 102). The batteries and corresponding BMUs connect to a DC bus 304 and a DC PLC 306. Similarly, the microinverters connect to the DC bus 304, a DC PLC 306 and an AC bus (e.g., the bus 108). In at least some embodiments, the DC PLC 306 allows the BMUs and the microinverters to communicate with each other. Alternatively or additionally, in at least some embodiments, the DC bus 304 can comprise a four pin/four wire system with two wires for communication. In at least some embodiments, the microinverters can communicate with the system controller 106 (e.g., the gateway) via a control area network (CAN), as described below. In FIG. 3, the battery chassis 302 is shown comprising four batteries and corresponding BMUs and three microinverters. In the embodiment of FIG. 3, the four batteries are configured to provide 5.6 KWh (e.g., 4*1.4 KWh) and the microinverters are configured to provide 2.16 KW (e.g., 3*720 VA). Additionally, a C-rate of the configuration of FIG. 3 is about 0.385. As noted above, the number of batteries and microinverters can be changed as needed based on a user preference.

For example, FIG. 4 is a diagram 400 of a chassis comprising a plurality of batteries and microinverters configured for use with the AC battery system of FIG. 2, in accordance with at least some embodiments of the present disclosure. The battery/microinverter configuration of FIG. 4 is substantial identical to the battery/microinverter configuration of FIG. 3. Unlike the battery/microinverter configuration of FIG. 3, a battery chassis 402 can house three batteries and corresponding BMUs and four microinverters. The three batteries are configured to provide 4.2 KWh (e.g., 3*1.4 KWh) and the microinverters are configured to provide 2.88 KW (e.g., 4*720 VA). Additionally, a C-rate of the configuration of FIG. 4 is about 0.55. Thus, the battery/microinverter configuration of FIG. 4 provides a user with less KWh, more KW, and a higher C-rate when compared to the battery/microinverter configuration of FIG. 3.

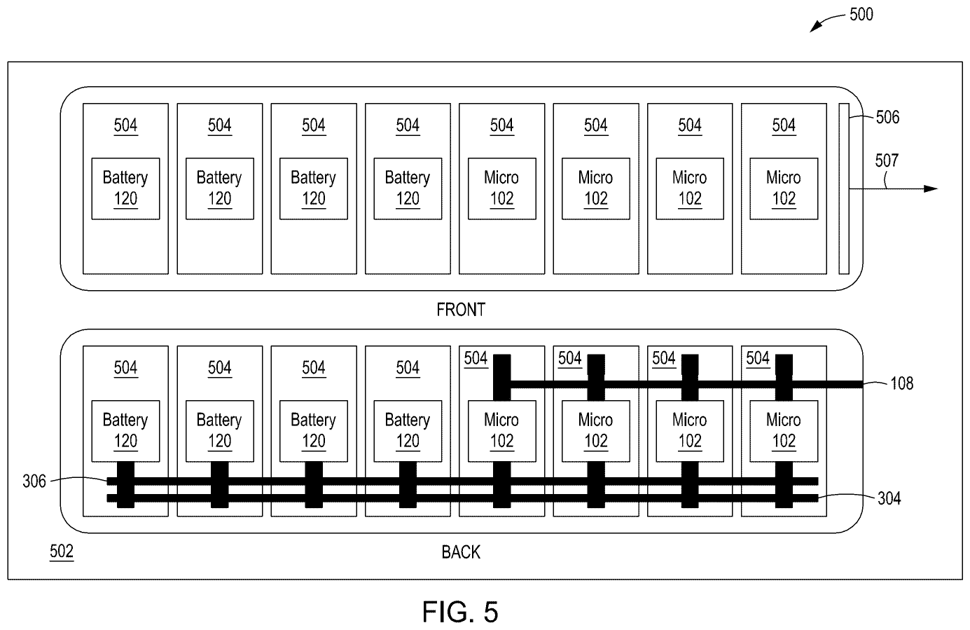

FIG. 5 is a diagram 500 of a chassis comprising a plurality of batteries and microinverters configured for use with the AC battery system of FIG. 2, in accordance with at least some embodiments of the present disclosure. For example, a battery chassis 502 can have 1, 2, 3, 4, 5, 6, etc. slots 504 that are configured to house one or more batteries and microinverters. Each slot 504 can be configured to house either a battery or a microinverter, and there can be any ratio of batteries (and BMUs) to microinverters. For example, the battery/microinverter configuration in FIG. 5 can comprise a one-to-one ratio of batteries to microinverters. In at least some embodiments, the battery chassis 502 can have eight slots 504 that are configured to house four batteries and four microinverters (e.g., front and back of the battery chassis 502 are shown). In at least some embodiments, the battery chassis 502 can have up to twelve slots that are configured to house six batteries and six microinverters (e.g., front and back of the battery chassis 502). In at least some embodiments, one of the slots can be used to house a controller 506 that is configured to connect to a control area network (CAN) bus 507 for communicating with other components of the system 100 (e.g., the AC battery system, the gateway, a combiner, external MID or IID 140, etc.). Alternatively, the battery chassis 502 can comprise a dedicated slot (not shown) for the controller 506.

In at least some embodiments, microinverters in a modular rack configuration may be configured for a power conversion infrastructure for data centers. For example, when arranged in large numbers—potentially hundreds per rack—such devices can be engineered and controlled to collectively perform high-voltage AC to medium-voltage DC conversion, e.g., as a solid state transformer comprised of numerous modular microinverters. For example, a system could be designed to step down three-phase AC at tens of kilovolts to a stable DC bus voltage on the order of hundreds of volts, suitable for direct use in data center power distribution. Such an approach leverages the inherent modularity of microinverters, allowing for dynamic load balancing, redundancy, and simplified maintenance, while also enabling granular monitoring and control of power flows.

Additionally, in the foregoing embodiments, batteries traditionally used for energy storage or buffering may be replaced by direct power demand from the data center itself. This substitution allows the microinverter array to operate as a real-time transformer and rectifier, directly supplying DC power to servers, cooling systems, and other infrastructure. Such a configuration could reduce conversion losses, improve power quality, and enhance system resilience by decentralizing the conversion process. Moreover, the modular nature of microinverters supports flexible scaling and rapid deployment, making this architecture particularly attractive for edge data centers or facilities with variable load profiles.

While the foregoing is directed to embodiments of the present disclosure, other and further embodiments of the disclosure may be devised without departing from the basic scope thereof, and the scope thereof is determined by the claims that follow.

1. A storage system configured for use with an energy management system, comprising:
a chassis comprising a plurality of slots configured to house a plurality of batteries and corresponding battery management units and a plurality of microinverters such that a user can selectively add/remove either a battery of the plurality of batteries or a microinverter of the plurality of microinverters to obtain at least one of a predetermined amount of KWh, KW, or C-rate.

2. The storage system of claim 1, wherein the plurality of batteries and corresponding battery management units and the plurality of microinverters are configured to connect to at least one of a DC bus, a DC PLC, and wherein the plurality of microinverters are configured to connect to an AC bus.

3. The storage system of claim 2, wherein each slot of the plurality of slots provides about 1.4 KWh, 720 VA, and the C-rate of about 0.1 to about 4 C when the plurality of batteries and corresponding battery management units and the plurality of microinverters are connected to the chassis.

4. The storage system of claim 1, wherein the plurality of slots comprises up to eight slots.

5. The storage system of claim 1, wherein the plurality of slots comprises up to twelve slots.

6. The storage system of claim 1, wherein at least one of the plurality of slots is configured to house a controller that is configured to connect to a control area network (CAN) bus.

7. An energy management system, comprising:
a DC power source connected to a power converter to convert DC power from the DC power source to grid-compliant AC power that is coupled to an AC bus; and
a storage system comprising a chassis comprising a plurality of slots configured to house a plurality of batteries and corresponding battery management units and a plurality of microinverters such that a user can selectively add/remove either a battery of the plurality of batteries or a microinverter of the plurality of microinverters to obtain at least one of a predetermined amount of KWh, KW, or C-rate.

8. The energy management system of claim 7, wherein the plurality of batteries and corresponding battery management units and the plurality of microinverters are configured to connect to at least one of a DC bus, a DC PLC, and wherein the plurality of microinverters are configured to connect to the AC bus.

9. The energy management system of claim 7, wherein each slot of the plurality of slots provides about 1.4 KWh, 720 VA, and the C-rate of about 0.1 to about 4 C when the plurality of batteries and corresponding battery management units and the plurality of microinverters are connected to the chassis.

10. The energy management system of claim 7, wherein the plurality of slots comprises up to eight slots.

11. The energy management system of claim 7, wherein the plurality of slots comprises up to twelve slots.

12. The energy management system of claim 7, wherein at least one of the plurality of slots is configured to house a controller that is configured to connect to a control area network (CAN) bus.
